(19) United States
(12) Patent Application Publication
(10) Pub. No.: US 2026/0340057 A1
(43) Pub. Date: Oct. 29, 2026

(54) OPTIMIZING SEARCH ENGINE RESULTS

(71) Applicants: Raj SHAH, Bloomingdale, IL (US); Anum MITHANI, Bloomingdale, IL (US)

(72) Inventors: Raj SHAH, Bloomingdale, IL (US); Anum MITHANI, Bloomingdale, IL (US)

(21) Appl. No.: 19/107,873

(22) PCT Filed: Oct. 5, 2023
(86) PCT No.: PCT/US23/76142

§ 371 Date: Feb. 28, 2025

Related U.S. Application Data
(60) Provisional application No. 63/378,617, filed on Oct. 6, 2022.

(51) Int. Cl. G06F 16/9538; G06F 16/955

(52) U.S. Cl. CPC G06F 16/9538; G06F 16/955

(57) ABSTRACT

Methods and systems for optimizing search engine results are provided. In some examples a plurality of posts are received. Each of the plurality of posts includes a title and a uniform resource link (URL). Further, each post of the plurality of posts includes at least one of a tag, a category, or a keyword. From the plurality of posts, at least one post that is determined to include a predetermined stopword, in the respective title or URL of the post, is removed. From the plurality of posts, at least one post is filtered to remove predefined common words from the title and the at least one of the tag, category, and keyword of each respective post. After removing and filtering, a score is calculated for each post of the plurality of posts. For the plurality of posts, each post and respective scores of each post are provided as an output.

### CROSS REFERENCE TO RELATED APPLICATIONS

This application claims priority to U.S. Provisional Application No. 63/378,617, entitled “OPTIMIZING SEARCH ENGINE RESULTS,” and filed on Oct. 6, 2022, which is incorporated by reference herein for all purposes in its entirety.

### BACKGROUND

This disclosure relates generally to search engine optimization, and more specifically to search engine optimization systems and methods for optimizing digital content for improved search engine results. Search engine optimization may be used in a variety of contexts, such as for blog posts, product pages, article pages, or other digital content that includes site mapping, search parameters, keyword placement, structured data, semantic Hypertext Markup Language (HTML), contextual internal linking, external citations, etc. Understanding factors rewarded by search engines is a continuing technical challenge being addressed by software engineers, developers, and SEO (search engine optimization) professionals.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for optimizing search engine results. In some examples, the search engine results are optimized for blogs.

Some examples include receiving a plurality of posts. Each post of the plurality of posts includes a title and a uniform resource link (URL), and each post of the plurality of posts includes at least one of a tag, a category, or a keyword. Some examples further include removing, from the plurality of posts, at least one post that is determined to include a predetermined stopword in the respective title or URL of the post, filtering, from the plurality of posts, at least one post to remove predefined common words from the title and the at least one of the tag, category, and keyword of each respective post, calculating, after removing and filtering, a score for each post of the plurality of posts, and providing, for the plurality of posts, as an output, each post and the respective scores of each post.

Some examples further include generating a caption for insertion into at least one post of the plurality of posts, based on the score, and inserting the caption into the at least one post of the plurality of posts.

In some examples, the plurality of posts are received from a database, and the output is provided to the database.

Some examples include determining that a post of the plurality of posts contains a priority keyword in the post's title or URL, and in response to determining, increasing the score.

In some examples, the titles include a first weight, the tags include a second weight, the categories include a third weight, and the keywords include a fourth weight. Further, the score is based on the first weight and at least one of the second, third, and fourth weights.

In some examples, the first weight is greater than the second weight, the second weight is greater than the third weight, and the third weight is greater than the fourth weight.

In some examples, the first weight is a value of between about 0.7 and about 0.9.

In some examples, the plurality of posts are a plurality of blog posts.

Some examples include a first device, a second device that includes a processor, and memory storing instructions that, when executed by the processor, cause the system to perform a set of operations. The set of operations include: receiving, from the first device, a plurality of posts. Each post of the plurality of posts includes a title and a uniform resource link (URL), and each post of the plurality of posts includes at least one of a tag, a category, or a keyword. The set of operations further include removing, from the plurality of posts, at least one post that is determined to include a predetermined stopword in the respective title or URL of the post, filtering, from the plurality of posts, at least one post to remove predefined common words from the title and the at least one of the tag, category, and keyword of each respective post, calculating, after removing and filtering, a score for each post of the plurality of posts, and generating a graphical user-interface (GUI), based on the score.

In some examples, the first device includes a software plug-in. Some examples include sending each post and the respective score of each post to the software plug-in.

In some examples the second device is a server.

In some examples, the graphical user interface comprises a plurality of images, corresponding to the plurality of posts.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates an example flow, according to some aspects described herein.

FIG. 3 illustrates an example flow, according to some aspects described herein.

FIG. 4 illustrates a detailed view of a portion of the example flow of FIG. 3.

FIG. 5 illustrates an example inlink and outlink schematic diagram, according to some aspects described herein.

FIG. 6 illustrates an example graphical user-interface, according to some aspects described herein.

FIG. 7 illustrates an example graphical user-interface, according to some aspects described herein.

FIG. 8 illustrates an example method of optimizing search engine results, according to some aspects described herein.

FIG. 9 illustrates an example graphical user-interface, according to some aspects described herein.

FIG. 10 illustrates the example graphical user-interface of FIG. 9, in a second configuration, according to some aspects described herein.

FIG. 11 illustrates the example graphical user-interface of FIG. 9, in a third configuration, according to some aspects described herein.

FIG. 12 illustrates a block diagram illustrating example physical components of a computing device with which aspects of the disclosure may be practiced.

FIG. 13 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents. Further, throughout the disclosure, the terms “about”, “substantially”, and “approximately” mean plus or minus 5% of the number or geometric constraint that each term precedes. For example, about 100 may mean 100+/−5.

As mentioned above, this disclosure relates generally to search engine optimization, and more specifically to search engine optimization systems and methods for optimizing digital content for improved search engine results. Search engine optimization may be used in a variety of contexts, such as for blog posts, product pages, article pages, or other digital content that includes site mapping, search parameters, keyword placement, etc. Understanding factors rewarded by search engines is a continuing technical challenge being addressed by software engineers, web developers, graphic designers, data analysts, content writers, and SEO (search engine optimization) professionals.

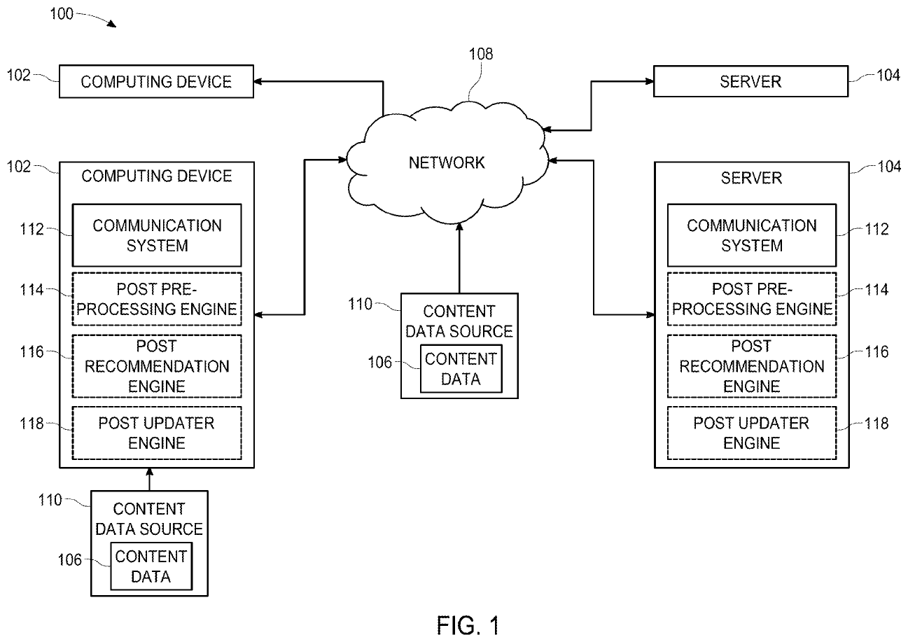

FIG. 1 shows an example of a system 100, in accordance with some aspects of the disclosed subject matter. The system 100 may be a system for optimizing search engine results. Additionally, or alternatively, the system 100 may be a system for displaying search engine results on a post (e.g., blog post, product page, product listing page, article page, a webpage, a portion of a webpage, etc.). The system 100 includes one or more computing devices 102, one or more servers 104, a content data source 106, and a communication network or network 108. The computing device 102 can receive content data 110 from the content data source 106, which may be, for example a database, a repository, a computer-executed program that generates content data 110, and/or memory with data stored therein corresponding to content data 110. The content data 110 may include a blog post, a webpage, a product page, a product listing page, a portion of a webpage, a virtual document, a virtual image, a digital content item, a title, a tag, a category, a keyword, a modification date, a publication date, an author display name, an author uniform resource link, impressions, rankings, and clicks content data, and/or a combination of the aforementioned elements. Additional and/or alternative types of content data that may be recognized by those of ordinary skill in the art.

Additionally, or alternatively, the network 108 can receive content data 110 from the content data source 106, which may be, for example a database, a repository, a computer-executed program that generates content data 110, and/or memory with data stored therein corresponding to content data 110. The content data 110 may include a blog post, a webpage, a product page, a product listing page, a web page, a portion of a webpage, a virtual document, a virtual image, a digital content item, a title, a tag, a category, a keyword, a modification date, a publication date, an author display name, an author uniform resource link, impressions, clicks, and/or a combination of the aforementioned elements. Additional and/or alternative types of content data that may be recognized by those of ordinary skill in the art.

Computing device 102 may include a communication system 112, a post pre-processing engine or component 114, a post recommendation engine or component 116, and/or a post updater engine or component 118. In some examples, computing device 102 can execute at least a portion of the post pre-processing component 114 to remove certain posts from further processing, and or content of the posts from further processing, based on predetermined words. For example, predetermined “stopwords” may be defined that indicate that a post containing such a word is irrelevant.

Further, in some examples, computing device 102 can execute at least a portion of the post recommendation component 116 to generate list of recommended posts, based on a calculated comparison score (e.g., calculated based on titles, tags, categories, and/or key words of a post). Still further, in some examples, the computing device 102 can execute at least a portion of the post updater component 118 to display and/or embed one or more posts from the list of recommended posts (e.g., from the post recommendation component 116) onto a graphic user-interface, such as, of a web page. The post updater component 118 can be configured to create posts and/or to update posts that have already been created (e.g., at a specified regular or irregular interval of time).

Server 104 may include a communication system 112, a post pre-processing engine or component 114, a post recommendation engine or component 116, and/or a post updater engine or component 118. In some examples, server 104 can execute at least a portion of the post pre-processing component 114 to remove certain posts from further processing, and or content of the posts from further processing, based on predetermined words. For example, predetermined “stopwords” may be defined that indicate that a post containing such a word is irrelevant.

Further, in some examples, server 104 can execute at least a portion of the post recommendation component 116 to generate list of recommended posts, based on a calculated comparison score (e.g., calculated based on titles, tags, categories, and/or key words of a post). Still further, in some examples, the server 104 can execute at least a portion of the post updater component 118 to display and/or embed one or more posts from the list of recommended posts (e.g., from the post recommendation component 116) onto a graphic user-interface, such as, of a web page.

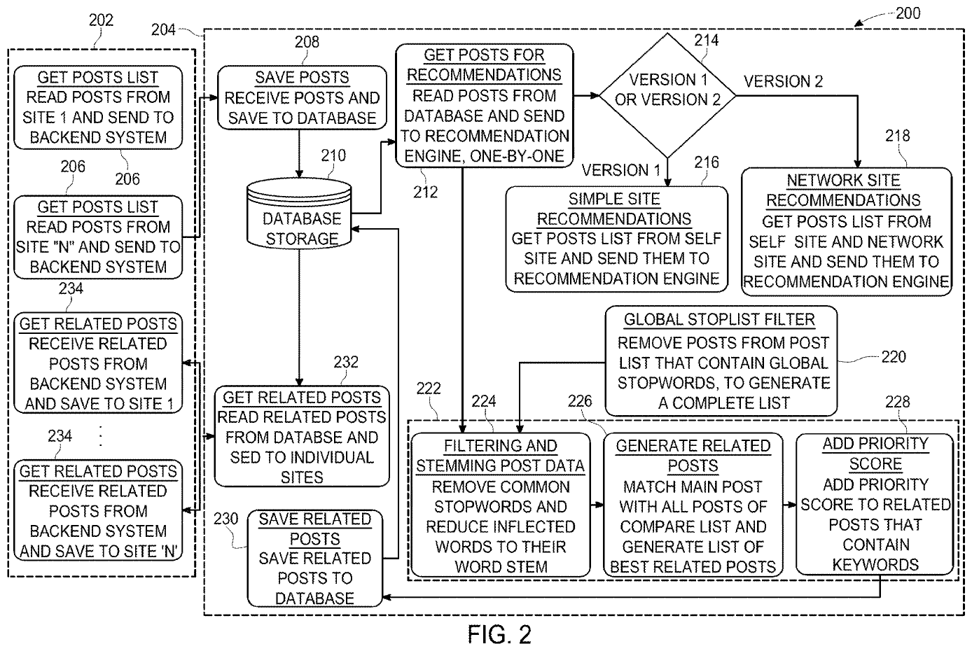

Additionally, or alternatively, in some examples, computing device 102 can communicate data received from content data source 106 to the server 104 over a communication network 108, which can execute at least a portion of the post pre-processing component 114, the post recommendation component 116, and/or the post updater component 118. In some examples, the post pre-processing component 114 may execute one or more portions of flows/methods/processes 200, 300, 400 and/or 800 described below in connection with FIGS. 2, 3, 4, and 8, respectively. Further in some examples, the post recommendation component 116 may execute one or more portions of flows/methods/processes 200, 300, 400, and/or 800 described below in connection with FIGS. 2, 3, 4, and 8, respectively. Further, in some examples, the post updater component 118 may execute one or more portions of flows/methods/processes 200, 300, 400, and/or 800 described below in connection with FIGS. 2, 3, 4, and 8, respectively.

In some examples, computing device 102 and/or server 104 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 102 and/or a plurality of servers 104.

In some examples, content data source 106 can be any suitable source of content data, such as a database or repository for a blog, a product, an online store, etc. In some examples, content data source 106 can include memory storing content data (e.g., local memory of computing device 102, local memory of server 104, cloud storage, portable memory connected to computing device 102, portable memory connected to server 104, etc.). In some examples, content data source 106 can include an application configured to generate content data. In some examples, content data source 106 can be local to computing device 102. Additionally, or alternatively, content data source 106 can be remote from computing device 102 and can communicate content data 110 to computing device 102 (and/or server 104) via a communication network (e.g., communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

FIG. 2 illustrates an example flow 200, according to some aspects described herein. The example flow 200 contains one or more processes or components that are performed or executed via a plug-in 202 and one or more processes or components that are performed or executed via a server 204. In some examples, the server 204 is a back-end system that receives data from the plug-in 202 (e.g., a front-end system). In some examples, the plug-in 202 is a software component that is installed on a client-side device (e.g., computing device 102). Accordingly, a user may provide permission for the plug-in 202 to be installed on their local device to interact with computational resources of the local device. The plug-in 202 may enhance a user's experience by providing functionality described herein related to improving search engine results.

In some examples, the plug-in 202 is a software component that is configured to be enabled on a first device (e.g., computing device 102), while being installed on a second device that is remote from the first device. Further, while in the illustrated example 200, one or more processes or components are performed or executed by a server 204, it should be recognized that the same or similar processes or components may be performed or executed by a computing device (e.g., computing device 102).

Flow 200 begins at component 206, wherein posts are received from a site (e.g., a web site, such as a blog, an online retailer, a product page, a search console, etc.) and sent to the backend system 204. In some example, the posts are read, extracted, or otherwise obtained from a site. Further, at component 206, posts may be received from a plurality of sites. Additionally, or alternatively, in some examples, the plug-in 202 may send information corresponding to a post, such as information corresponding to a blog post, a webpage, a product page, a product listing page, an article listing page, a virtual document, a virtual image, a webpage, a portion of a webpage, a digital content item, a title, a tag, a category, a keyword, a modification date, a publication date, an author display name, an author uniform resource link, impressions, clicks, and/or a combination of the aforementioned elements. Additional and/or alternative types of content data that may be aggregated by a plug-in, such as plug-in 202, and transmitted to a backend system, such as backend system 204, may be recognized by those of ordinary skill in the art.

In some examples, the content data aggregated by the plug-in 202 may be used to drive insights to a user base (e.g., one or more users of, or clients for, mechanisms provided herein). For example, the content data (e.g., post data, such as blog post data, article data, product data, webpage data, portions of webpage data, etc.) and/or derivative metrics based thereon can be provided to an application (e.g., interactive application) that provide an overview of content data, such as a dashboard, cockpit view, or the like. Additionally, or alternatively, the content data aggregated by the plug-in 202 can be used to provide an indication of data metrics to users (e.g., via push notifications, such as mobile push notifications, email notifications, short-message-service notifications, in-app notifications, web-push notifications, phone call notifications, or the like).

At component 208, the posts from component 206 are received. The posts are received by the backend system 204 and saved to a database storage or data repository 210. In some examples, the data repository 210 may include random access memories, flat files, XML files, and/or one or more database management systems (DBMS) executing on one or more database servers or a data center. In some examples, a database management system may be a relational (RDBMS), hierarchical (HDBMS), multidimensional (MDBMS), object oriented (ODBMS or OODBMS) or object relational (ORDBMS) database management system, and the like. In some examples, the data repository may be, for example, a single relational database. In some examples, the data repository may include a plurality of databases that can exchange and aggregate data by data integration process or software application. In some examples, at least part of the data repository 210 may be hosted in a cloud data center. In some examples, a data repository may be hosted on a single computer (e.g., computing device 102), a server (e.g., server 104), a storage device, a cloud server, or the like. In some examples, the data repository 210 may be hosted on a series of networked computers, servers, or devices. In some examples, the data repository 210 may be hosted on tiers of data storage devices including local, regional, and central.

At component 212 posts are received from the database 210 and sent to a recommendation engine, one-by-one. The posts may be read, extracted, or otherwise obtained from the database 210. In some examples, prior to sending the posts to the recommendation engine, the flow 200 may include a component 214 at which it is determined if a user has a first version or a second version of software components described herein. The first version may correspond to a free version and the second version may correspond to a pro-version or paid version. Alternatively, in some examples, the first version may be associated with a first cost (e.g., monetary or computational cost) that is less than a second cost that is associated with the second version.

If it is determined that the user has the first version, then the flow 200 proceeds to component 216, wherein a post list is received from a self-site. In some examples, a post list associated with a self-site may be a list of posts that all contain the same author. In some examples, a post list associated with a self-site may be a list of posts that are all associated with the same product, or brand, or organization, or corporation.

Alternatively, if it is determined that the user has the second version, then the flow 200 proceeds to component 218, wherein a post list from a self-site and a network-site are received. The post list from the self-site is described above with respect to component 216. In some examples the post list associated with the network-site may be all posts that are available on a given network. For example, the post list may include all posts that are available within a blog community, a blog platform, a search engine platform, etc. The post list for the network-site may include lists of posts that contain different authors, and/or that are associated with different products, or brands, or organization, or corporations, etc.

At component 220, the post lists from component 216 and/or component 218 are then filtered, based on a list of stopwords, to generate a compare list. Stopwords, as defined herein, are any words that are predefined by a system or user to indicate that a post containing such a word is irrelevant. At component 220, it is determined whether one or more posts from the post lists contain a stopword, and, if so, then posts that contain the stopwords are removed from the post lists. The post list with posts removed, based on the stopwords, is the generated compare list. The compare list is then sent to a recommendation engine 222, along with a main post list, from component 212.

The recommendation engine 222 contains component 224, 226, and 228. At component 224 posts are filtered and stemmed. For example, common stopwords are removed from the received compare list and the received main post list. The posts with the stopwords removed then have their inflected words reduced to their word stem. The main post list and the compare post list, after being filtered and stemmed, are received by component 226.

At component 226 a list of related posts is generated, based on the main post list and the compare post list (e.g., after the main post list and the compare post list have been filtered and stemmed at component 224). The related post list may be generated by matching or comparing (e.g., based on similarity), each post of the main post list with each post of the compare list, to determine which posts are most related (e.g., calculated to be most similar) between the two lists. The posts which are most related form the related posts list. In some examples, posts may be calculated to be most similar based on a predetermined threshold score of similarity, such that if a calculated similarity score is greater than the predetermined threshold score, then the posts from which the similarity was calculated are included on the related posts list. Additionally, or alternatively, the related posts list may accommodate a predetermined number of posts, such that the most related posts, up to the predetermined number of posts, are included on the related posts list.

The related posts list is received by or sent to component 228. At component 228 a priority score is added to each post on the related posts list that contains a priority keyword. The priority keyword may be pre-determined by a system or user. In an example, the priority keyword is a list of priority keywords that includes “Christmas,” “Cricut,” and “Cricut Maker.” A first post example, related to the example list of priority keywords, may read “Christmas Day Art Made with Cricut.” For the first post examples, a first related post that reads “DIY Stenciled Christmas Pillow with Cricut” may be boosted because it contains the keywords “Christmas” and “Cricut,” which are in the example first post example's keyword list (e.g., “Christmas” and “Cricut”). Still referring to the first post example, a second related post that reads “Baby Yoda Valentines Ideas with Cricut” may be boosted because it contains the keywords “Cricut” which is in the first post example's keyword list (e.g., “Christmas” and “Cricut”). A third related post that reads “Personalized Christmas Gift Ideas for with the Cricut Maker” will not be boosted because it contains three keywords (e.g., “Christmas”, “Cricut” and “Cricut Maker”), but the main post only contains two keywords (e.g., “Christmas” and “Cricut”).

A second post example, related to the above-example list of priority keywords, may read “Valentine's Day Art Made with Cricut.” For the second post example, a first related post that reads “Baby Yoda Valentines Ideas with Cricut” will be boosted because it contains one keyword and the second post example also contains the one keyword (e.g., Cricut). Still referring to the second post example, a second related post that reads “Easy Christmas Craft Paper Heart Garland with Cricut” will not be boosted because it contains two keywords (e.g., “Christmas” and “Cricut”), but the main post only contains one keyword (e.g., “Cricut”). Additional and/or alternative examples for when a score for related posts may be boosted (e.g., increased), based on keywords, may be recognized by those of ordinary skill in the art.

At component 230, the list of related posts, from the recommendation engine 222 are saved to the database 210. The list of related posts may contain corresponds scores, based on the similarities calculated by component 226 and/or the keyword analysis performed by component 228.

At component 232, a list of related posts are read, received, and/or obtained from the database storage 210. The related posts are then sent to individual sites a site (e.g., a web site, such as a blog, an online retailer, a product page, etc.). For example, the related posts may be sent to the plug-in 202, and the plug-in 202 may be configured to send the related posts to the individual sites.

At component 234, related posts are received from the backend system 204. The related posts may be received at the plug-in 202. Further, the related posts may be saved to a site (e.g., a web site, such as a blog, an online retailer, a product page, etc.). The related posts may be saved to a page of a website, such that the website is updated to include content from the post. In some examples, a graphical-user interface associated with the page of the website is updated to include content from one or more posts of the related posts, within the graphical-user interface. For example, the graphical-user interface may be updated to include a title, or an author, or a description, or a keyword, or an image, or a video associated with the post, within the graphical-user interface (e.g., in a footer, in a lower portion of the interface, in the body of the interface, etc.). In some examples, the related posts and/or content therefrom may be saved to a page of a blog post, a product page, a product listing page, an article listing page, a homepage, or another type of digital page that may be recognized by those of ordinary skill in the art.

In some examples, one or more author profile pages may be created. In some examples, each author profile page may correspond to a specific user who authors one or more posts. In some examples, the relevant posts may be the top posts associated with an author, such that the top posts are featured on an author profile page associated with the author. In some examples, the top posts may be determined based on a number of clicks and/or impressions associated with the author's posts, such that the top posts are the posts by the author with the highest number of clicks and/or impressions. In some examples, an author is a single person. In some examples, an author is a group of people (e.g., editorial staff). In some examples, an author is an entity (e.g., a publication, corporation, organization, etc.).

In some examples, users may have the ability to not show one or more related posts generated by the recommendation engine 222. Instead, in some examples, users can instead choose specific posts (e.g., posts for which the users are authors) to show (e.g., on a content page). In some examples, in a web interface (e.g., customer portal, content management system (CMS), etc.) users can view a list of related posts with their corresponding priority scores (e.g., from component 223) and determine which posts to show. For example, if a list of related posts are currently being displayed, a user can update the list of related posts to include related posts other than the currently displayed related posts, such as by selecting the other relates posts based on their priority scores.

In some example implementations of the processes discussed herein (e.g., flow 200, flow 300, flow 400, and/or method 800), mechanisms provided herein may receive one or more posts (e.g., webpages) from one or more feeds (e.g., data sources), such as via components 206. For example, the multiple feeds may include a product feed that lists one or more of an organization's product webpages. In some examples, the multiple feeds include a list of one or more blog pages and/or article pages. In some examples, the multiple feeds include a vehicle feed that has a list of one or more vehicle manuals. In some examples, the one or more feeds send the one or more posts to the server 204, such as for computations to be performed and/or for similar posts to be determined. In some examples, similar posts (e.g., determined by the recommendation engine 222), such as from the multiple feeds, may be sent to a client device (e.g., computing device 102). In some examples, a product page may be adapted to show similar and/or related products, blog posts, article posts, and/or vehicle manuals. As another example, a blog page and/or article page may be adapted to show corresponding products and/or vehicle manuals.

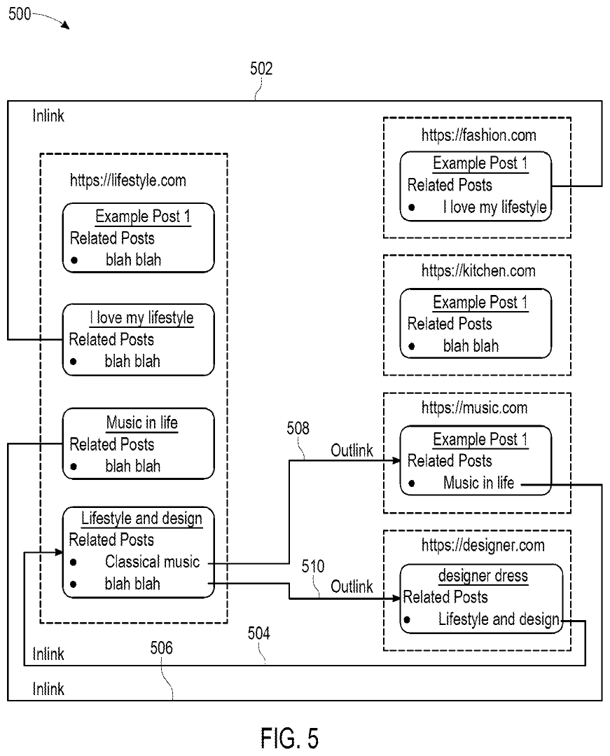

In some example implementations of the processes discussed herein (e.g., flow 200, flow 300, flow 400, and/or method 800), mechanisms provided herein may create a network of content from one website to another. For example, a plurality of different organizations may each have respective websites. In some examples, each of those respective websites can send one or more feeds to systems provided herein and be returned relevant recommendations (e.g., based on the recommendation engine 116, 222, 318). In some examples, a webpage (e.g., of a first organization) can display results from its own webpage as well as one or more other webpages (e.g., of a second organization, a third organization, etc.), such as via the post updater engine 118 and/or component 234. In some examples, the first organization (e.g., corresponding to the webpage) may own or otherwise be associated with the second and third organizations (e.g., corresponding to the one or more other webpages). Some specific examples of linking results from webpages to other webpage are discussed further herein, such as with respect to FIGS. 5-7 and 11.

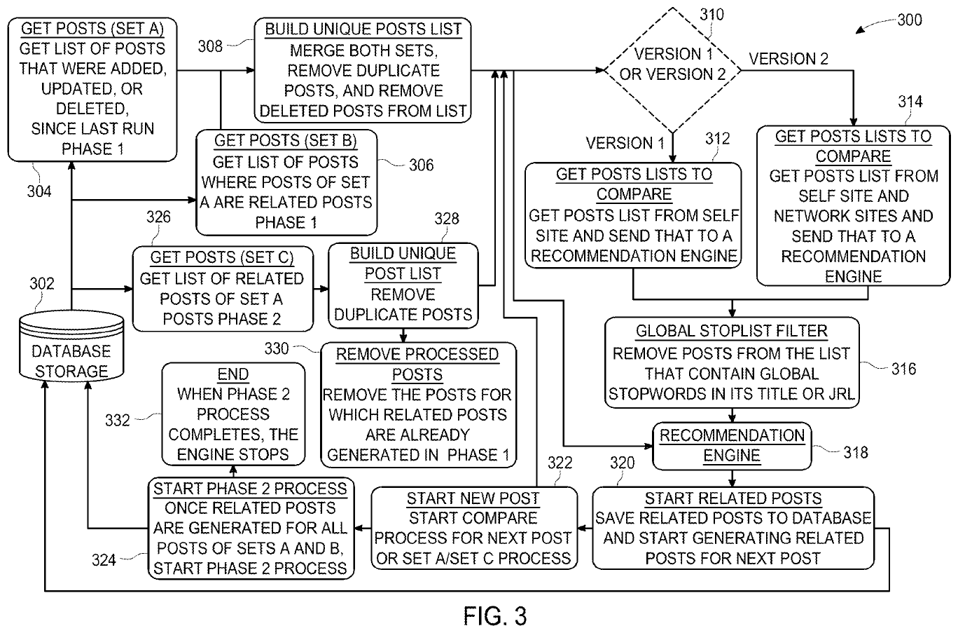

FIG. 3 illustrates an example flow 300, according to some aspects described herein. The example flow 300 contains one or more processor or components that are performed or executed (e.g., by a backend system, such as a computing device or server). In some examples, aspects of the flow 300 may be similar to aspects of the flow 200. Additionally, or alternatively, in some examples, aspects of the flow 300 may be different than aspects of the flow 200.

The flow 300 begins at a database storage or data repository 302. The database storage 302 includes a list of posts (e.g., from blogs, product pages, online retailers, search consoles, etc.). In some examples, the posts are blog posts, webpages (e.g., pages posted on the internet), portions of webpages, product pages, product listing pages, article pages, article listing pages, and/or other types of digital content items which should be recognized by those of ordinary skill in the art. In some examples, the data repository 302 may include random (DBMS) executing on one or more database servers or a data center. In some examples, a database management system may be a relational (RDBMS), hierarchical (HDBMS), multidimensional (MDBMS), object oriented (ODBMS or OODBMS) or object relational (ORDBMS) database management system, and the like. In some examples, the data repository may be, for example, a single relational database. In some examples, the data repository may include a plurality of databases that can exchange and aggregate data by data integration process or software application. In some examples, at least part of the data repository 302 may be hosted in a cloud data center. In some examples, a data repository may be hosted on a single computer (e.g., computing device 102), a server (e.g., server 104), a storage device, a cloud server, or the like. In some examples, the data repository 302 may be hosted on a series of networked computers, servers, or devices. In some examples, the data repository 302 may be hosted on tiers of data storage devices including local, regional, and central.

At component 304, a first subset of posts, from a list of posts contained within the database storage 302, are received, extracted, or otherwise obtained from the database storage 302. The first list of posts may include posts that were added, updated, or deleted since a previous iteration of the flow 300.

At component 306, a second subset of posts, from the list of posts contained within the database storage 302, are received, extracted, or otherwise obtained from the database storage 302. The second list of posts may include posts that are determined to be related to the first subset of posts, from component 304. The component 304 and component 306 may form, in part, a first phase of the flow 300.

At component 308, a unique post list is compiled. The unique post list merges the first subset of posts (e.g., from component 304) and the second subset of posts (e.g., from component 306). Component 308 may further remove posts that are indicated to be deleted, from the merged list of posts.

In some examples, prior to sending the merged list of posts to a recommendation engine, the flow 300 may include a component 310 at which it is determined if a user has a first version or a second version of software components described herein. The first version may correspond to a free version and the second version may correspond to a pro-version or paid version. Alternatively, in some examples, the first version may be associated with a first cost (e.g., monetary or computational cost) that is less than a second cost that is associated with the second version.

If it is determined that the user has the first version, then the flow 300 proceeds to component 312, wherein a post list is received from a self-site. In some examples, a post list associated with a self-site may be a list of posts that all contain the same author. In some examples, a post list associated with a self-site may be a list of posts that are all associated with the same product, or brand, or organization, or corporation.

Alternatively, if it is determined that the user has the second version, then the flow 300 proceeds to component 314, wherein a post list from a self-site and a network-site are received. The post list from the self-site is described above with respect to component 312. In some examples the post list associated with the network-site may be all posts that are available on a given network. For example, the post list may include all posts that are available within a blog community, a blog platform, a search engine platform, etc. The post list for the network-site may include lists of posts that contain different authors, and/or that are associated with different products, or brands, or organization, or corporations, etc.

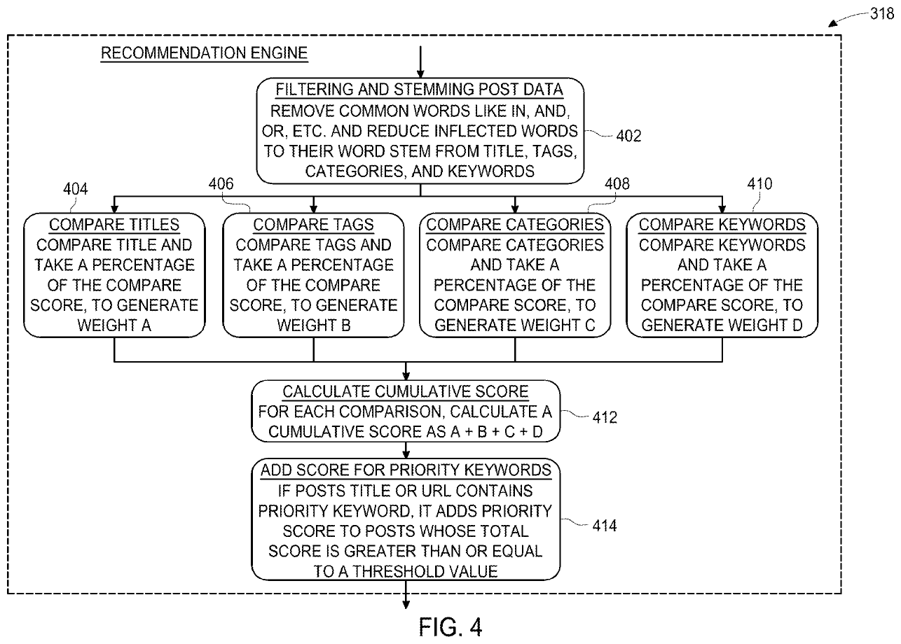

At component 316, the post lists from component 312 and/or component 314 are then filtered, based on a list of stopwords, to generate a compare list. Stopwords, as defined herein, are any words that are predefined by a system or user to indicate that a post containing such a word is irrelevant. At component 316, it is determined whether one or more posts from the post lists contain a stopword, and, if so, then posts that contain the stopwords are removed from the post lists. The post list with posts removed, based on the stopwords, is the generated compare list. The compare list is then sent to a recommendation engine or component 318, along with the merged post list from component 308, to generate a list of related posts. The recommendation component 318 is described in further detail herein with respect to FIG. 4.

At component 320, the list of related posts (e.g., generated by the recommendation component 318) are saved to the database storage 302. In some examples, related posts may start to be generated for a next post, in response to the component 320 saving the related posts to the database storage 302.

At component 322, a loop may be triggered in which a compare process for a next post, from the merged list of posts (e.g., of component 308) begins. For example, a next post from the merged list of posts may iterate through components 310-322, until each post from the merged list of posts of component 308 have been analyzed.

At component 324, once related posts are generated for all posts of the first subset of posts (e.g., of component 304) and of the second subset of posts (e.g., of component 306), a second phase process of flow 300 may begin. In the second phase process, at component 326, a third subset of posts are received, extracted, or otherwise obtained from the database storage 302. The third subset of posts may include a list of related posts of the first subset of posts (e.g., from component 304), as determined by the recommendation component 318.

At component 328 a unique list of posts is built, based on the third subset of posts, from component 326. At component 328 any duplicate posts from the third subset of posts may be removed, to generate the unique list of posts.

At component 330, any posts, from the unique list of posts, for which related posts are already generated (e.g., from the first phase of the flow 300) are removed from the unique list of posts. The unique list of posts, having been processed by component 330, may then be sent to iterate through components 310-320, which were each described in detail earlier herein. When, the phase two process completes, and no further posts need to be sent through the recommendation component 318, then the flow 300 stops at component 332.

FIG. 4 illustrates a detailed view of a portion of the example flow 300 of FIG. 3. Specifically, FIG. 4 illustrates a detailed view of the recommendation engine or component 318. The recommendation engine or component 318 receives a list of posts (e.g., from the component 316). From the list of posts, at component 402, common words (e.g., “in”, “and”, “or”, etc.) are removed from each of the posts (e.g., from the titles or content of the posts). Additionally, or alternatively, inflected words from each of the posts (e.g., from a title, tag, category, keyword, etc.) are reduced to their stem word.

At component 404, titles between a post and the remaining posts from the list of posts are compared. For example, an embedding may be generated for each title, and the embedding may be mapped in a vector space, a distance between each of the embeddings may be used to calculate a similarity or compare score (e.g., embeddings which are closer together would have a relatively higher score than embeddings that are further apart). A percentage of the compare score may be taken to generate weight A. For example, the compare score of the title may be weighted between about 70% and about 90%, or at about 60%, or at about 70%, or at about 80%, or at about 90%, or at any range defined between the aforementioned values.

At component 406, tags between a post and the remaining posts from the list of posts are compared. For example, an embedding may be generated for each tag, and the embedding may be mapped in a vector space, a distance between each of the embeddings may be used to calculate a similarity or compare score (e.g., embeddings which are closer together would have a relatively higher score than embeddings that are further apart). A percentage of the compare score may be taken to generate weight B. For example, the compare score of the title may be weighted between about 5% and about 10%, or at about 5%, or at about 6%, or at about 7%, or at about 8%, or at about 9%, or at about 10%, or at about 15%, or at any range defined between the aforementioned values.

At component 408, categories between a post and the remaining posts from the list of posts are compared. For example, an embedding may be generated for each category, and the embedding may be mapped in a vector space, a distance between each of the embeddings may be used to calculate a similarity or compare score (e.g., embeddings which are closer together would have a relatively higher score than embeddings that are further apart). A percentage of the compare score may be taken to generate weight C. For example, the compare score of the title may be weighted between about 5% and about 10%, or at about 5%, or at about 6%, or at about 7%, or at about 8%, or at about 9%, or at about 10%, or at about 15%, or at any range defined between the aforementioned values.

At component 410, keywords between a post and the remaining posts from the list of posts are compared. For example, an embedding may be generated for each keyword, and the embedding may be mapped in a vector space, a distance between each of the embeddings may be used to calculate a similarity or compare score (e.g., embeddings which are closer together would have a relatively higher score than embeddings that are further apart). A percentage of the compare score may be taken to generate weight D. For example, the compare score of the title may be weighted between about 0% and about 10%, or at about 3%, or at about 4%, or at about 5%, or at about 6%, or at about 7%, or at any range defined between the aforementioned values.

At component 412, a cumulative score is calculated, between each of the posts of the list of posts, based on at least two of weights A, B, C, and D. Then, at component 414, the cumulative score may be increased, based on the presence of priority keywords in a post. In some examples, if a post's title or URL contains a priority keyword, then mechanisms described herein add a priority score to posts whose total cumulative score is greater than or equal to a threshold value. For example, the threshold value may be 0.20, such that for all of the posts with a score of greater than 0.20, a priority score is added to those posts, based on the presence of keywords in those posts.

The priority keyword may be pre-determined by a system or user. In an example, the priority keyword is a list of priority keywords that includes “Christmas,” “Cricut,” and “Cricut Maker.” A first post example, related to the example list of priority keywords, may read “Christmas Day Art Made with Cricut.” For the first post examples, a first related post that reads “DIY Stenciled Christmas Pillow with Cricut” may be boosted because it contains the keywords “Christmas” and “Cricut,” which are in the example first post example's keyword list (e.g., “Christmas” and “Cricut”). Still referring to the first post example, a second related post that reads “Baby Yoda Valentines Ideas with Cricut” may be boosted because it contains the keywords “Cricut” which is in the first post example's keyword list (e.g., “Christmas” and “Cricut”). A third related post that reads “Personalized Christmas Gift Ideas for with the Cricut Maker” will not be boosted because it contains three keywords (e.g., “Christmas”, “Cricut” and “Cricut Maker”), but the main post only contains two keywords (e.g., “Christmas” and “Cricut”).

A second post example, related to the above-example list of priority keywords, may read “Valentine's Day Art Made with Cricut.” For the second post example, a first related post that reads “Baby Yoda Valentines Ideas with Cricut” will be boosted because it contains one keyword and the second post example also contains the one keyword (e.g., Cricut). Still referring to the second post example, a second related post that reads “Easy Christmas Craft Paper Heart Garland with Cricut” will not be boosted because it contains two keywords (e.g., “Christmas” and “Cricut”), but the main post only contains one keyword (e.g., “Cricut”). Additional and/or alternative examples for when a score for related posts may be boosted (e.g., increased), based on keywords, may be recognized by those of ordinary skill in the art.

If a score is boosted based on the presence of keywords, as described above, then the component 414 may update the score from component 412, based on the equation: New Score=Old Score*(Priority_Keyword_Count+1), where the Priority_Keyword_Count is the number of priority keywords in both a main post and a related post to which the main post is being compared.

The weighting calculations described with respect to FIG. 4 are repeated until all posts that are received by the recommendation component 318 are processed. The cumulative score for each post, taking into consideration an increase in the scores, due to the presence of priority keywords in the posts, is then output by the recommendation component 318. The cumulative score for each post may be associated with its respective post (e.g., in a data structure or in a memory location that stores the posts and/or the scores), such that the scores and posts can be used for further processing.

FIG. 5 illustrates an example inlink and outlink schematic diagram 500, according to some aspects described herein. The schematic diagram 500 includes a plurality of inlinks, such as a first inlink 502, a second inlink 504, and a third inlink 506. The schematic diagram 500 further includes a plurality of outlinks, such as a first outlink 508 and a second outlink 510.

The first inlink 502 illustrates that a site fashion.com will show posts of lifestyle.com. The second inlink 504 illustrates that a site designer.com will show posts of lifestyle.com. The third inlink 506 illustrates that a site music.com will show posts of lifestyle.com. However, since there is no inlink between kitchen.com and lifestyle.com, the site kitchen.com will not show any posts from the site lifestyle.com.

The first outlink 508 shows that the site lifestyle.com will show posts of music.com. The second outlink 510 shows that the site lifestyle.com will show posts of designer.com. However, the site lifestyle.com will not show posts from fashion.com and/or kitchen.com because no outlink is defined between the site lifestyle.com and either of the sites fashion.com or kitchen.com.

To temporarily suspend a site, exclude processing of the site's posts, and prevent generating related posts from the site, an admin may deactivate the site. In some examples, the site may be deactivated by removing or not instantiating any inlinks or outlinks between the site and any other sites. Once a site is deactivated, a plug-in (e.g., plug-in 202 of FIG. 2) will not send posts to a backend system (e.g., the backend system 204) and a recommendation engine will not generate related posts for that site (e.g., the recommendation engine 222 or the recommendation engine 318). A site that is deactivated (or that was never activated) may be activated by a system or user, such that the recommendation engine will generate related posts for that site.

To permanently suspend a site from the backend system, a system or user may delete the site. When a site is deleted, all of the posts of the site will be deleted from the backend system (e.g., the database 210 or the database 302, described with respect to FIGS. 2 and 3, respectively). A deleted site will not be connected to the backend system and will not be processed by the recommendation engine.

In some examples, a plurality of sites can be stored in a database (e.g., the database 210 or the database 302). A system or user may be able to view a list of posts for each of the sites. Further, in some examples, mechanisms described herein may include a searchable index, with a user-interface, such that a user can search through the lists of posts, for each of the sites, via the user-interface.

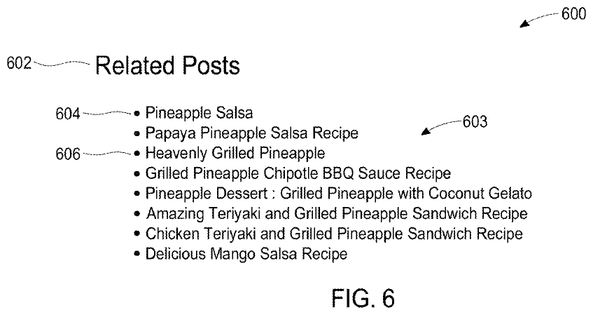

FIG. 6 illustrates an example graphical user-interface (GUI) or portion thereof 600, according to some aspects described herein. The GUI includes a title 602 and a plurality of related posts 603, such as a first related post 604 and a second related post 606. The title 602 may be displayed above the plurality of related posts 603 to indicate (e.g., to a user) that the plurality of related posts 603 are related posts. As shown in the GUI 600, the plurality of related posts 603 may include titles that are generated and/or displayed in a list. Further, the plurality of related posts 603 may include uniform resource links (URLs) that are hyperlinked to the GUI 600, such that a user can select one or more of the plurality of related posts 603, and in response, be directed to a site associated with the selected post. The plurality of related posts 603 may be calculated using mechanisms herein, such as with respect to flows 200 and 300.

In some examples, the GUI or portion thereof 600 is part of a website, such as a blog page. The GUI or portion thereof 600 may be embedded or displayed on a portion of a website, such as within a footer or lower portion of the website. For example, if the website is a blog site, then the title 602 and plurality of related posts 603 may be located, generally, at the bottom of the blog site. Additional and/or alternative examples may be recognized by those of ordinary skill in the art, at least in light of the teachings provided herein.

The GUI 600 boosts search engine optimization for a post on which the GUI 600 is displayed by linking out to relevant sources, on and/or off of an author's site. In some examples, the GUI 600 increases page views to related content which is linked through the plurality of related posts 603. In some examples, the GUI 600 create topical clusters, automatically, on a website on which the GUI 600 is displayed. In some examples, the GUI 600 syncs with a trust index, which is a collection of content that is determined to be trustworthy (e.g., determined by a user or a system).

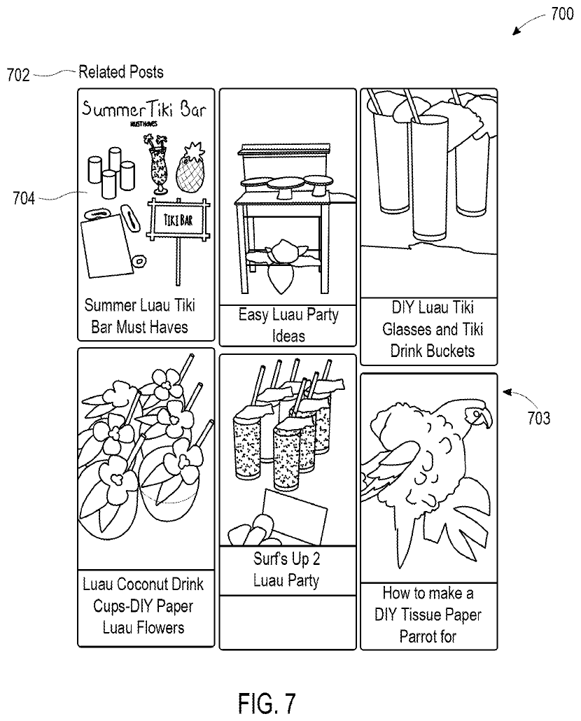

FIG. 7 illustrates an example graphical user-interface (GUI) or portion thereof 700, according to some aspects described herein. The GUI includes a title 702 and a plurality of related posts 703, such as a first related post 704 and a second related post 706. The title 702 may be displayed above the plurality of related posts 703 to indicate (e.g., to a user) that the plurality of related posts 703 are related posts. As shown in the GUI 700, the plurality of related posts 703 may include titles and/or images that are generated and/or displayed in a list. Further, the plurality of related posts 703 may include uniform resource links (URLs) that are hyperlinked to the GUI 700, such that a user can select one or more of the plurality of related posts 703, and in response, be directed to a site associated with the selected post. The plurality of related posts 703 may be calculated using mechanisms herein, such as with respect to flows 200 and 300.

In some examples, the GUI or portion thereof 700 is part of a website, such as a blog page. The GUI or portion thereof 700 may be embedded or displayed on a portion of a website, such as within a footer or lower portion of the website. For example, if the website is a blog site, then the title 702 and plurality of related posts 703 may be located, generally, at the bottom of the blog site. Additional and/or alternative examples may be recognized by those of ordinary skill in the art, at least in light of the teachings provided herein.

The GUI 700 boosts search engine optimization for a post on which the GUI 700 is displayed by linking out to relevant sources, on and/or off of an author's site. In some examples, the GUI 700 increases page views to related content which is linked through the plurality of related posts 703. In some examples, the GUI 700 create topical clusters, automatically, on a website on which the GUI 700 is displayed. In some examples, the GUI 700 syncs with a trust index, which is a collection of content that is determined to be trustworthy (e.g., determined by a user or a system).

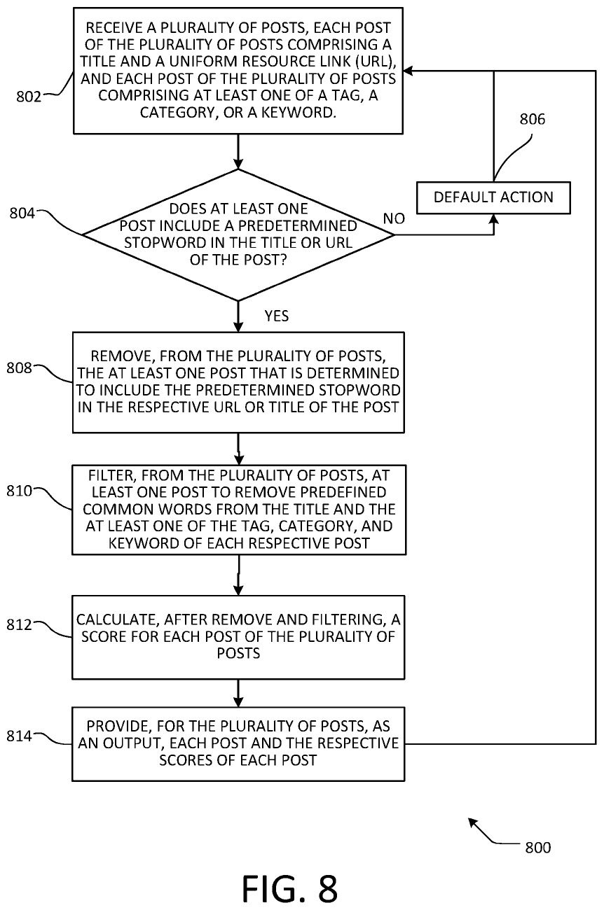

FIG. 8 illustrates an example method 800 of optimizing search engine results, according to some aspects described herein. In examples, aspects of method 800 are performed by a device, such as computing device 102 and/or server 104, discussed above with respect to FIG. 1.

Method 800 begins at operation 802, wherein a plurality of posts are received. The plurality of posts may be blog posts, product pages, product listing pages, article pages, article listing pages, virtual documents, websites (e.g., pages posted on the internet), portions of websites, and/or another type of digital content item that may be recognized by those of ordinary skill in the art. The plurality of posts may be received from one or more feeds, such as a product feed that includes a list of one or more product webpages, a content feed that includes a list of one or more blogs and/or articles, and/or a vehicle feed that includes a list of one or more vehicle manuals.

Each post of the plurality of posts may include a title and a uniform resource link (URL). Further, each post of the plurality of posts may include at least one of a tag, a category, or a keyword. The categories may be one or more categories, from a list of predetermined categories for a site, associated with the post or article. The tag may be one or more text strings that link to specific trends, people, or topics discussed on the post. The keywords may be one or more word that are determined to be important for the post (e.g., such as, because they are in the title of the post). In some examples, each of the plurality of posts includes at least two of a tag, a category, or a keyword.

At operation 804, it is determined if at least one post, of the plurality of posts, includes a predetermined stopword in the title or URL of the post. The predetermined stop word may come from a list of stopwords, defined by a user or system, that indicate that a post is irrelevant. For example, if a post includes a word such as “sponsorship” or “sweepstake,” then in a non-commercial context in which mechanisms herein are used, such words may be stopwords that prompt the posts that include such words to be irrelevant for the non-commercial context.

If it is determined that at least one post does not include a predetermined stopword in the title or URL of the post, flow branches “NO” to operation 806, where a default action is performed. For example, the plurality of posts may have an associated pre-configured action. In other examples, method 800 may comprise determining whether the plurality of posts have an associated default action, such that, in some instances, no action may be performed as a result of the received plurality of posts. Method 800 may terminate at operation 806. Alternatively, method 800 may return to operation 802 to provide an iterative loop of receiving a plurality of posts, and determining if at least one post of the plurality of posts includes a predetermined stopword in the title or URL of the post.

If, however, it is determined that at least one post includes a predetermined stopword in the title or URL of the post, flow instead branches “YES” to operation 808, where, the at least one post that is determined to include the predetermined stopword in the respective URL or title of the post is removed from the plurality of posts.

Flow advances to operation 810, wherein, from the plurality of posts, at least one post if filtered to remove predefined common words from the title and the at least one of the tag, category, and keyword of each respective post. The predefined common words may include “in”, “and”, “or”, etc. Generally, the predefined common words may be words that are not helpful in determining similarity between posts.

At operation 812, after removing and filtering (e.g., at operations 808 and 810), a score is calculated for each post of the plurality of posts. The score may be calculated after the removing and the filtering such that posts that are not relevant for a similarity analysis, have been removed from the plurality of posts, and words that are not relevant for a similarity analysis have been filtered, within each of the plurality of posts. The score may be calculated based on a plurality of weights that are respectively assigned to the title and the at least one of a tag, a category, or a keyword. For example, the title may include a first weight, the tag may include a second weight, the categories may include a third weight, and the keyword may include a fourth weight. The score may be based on the first weight and at least one of the second, third, and fourth weight.

In some examples, the first weight is greater than the second weight, the second weight is greater than the third weight, and the third weight is greater than the fourth weight. Such a proportional weighting between elements to which the weights are assigned may increase a desired accuracy of the calculated score.

At operation 814, for the plurality of posts, each post and the respective score of each post are provided as an output. In some examples, the output may be provided to a database (e.g., a database for a computing device and/or a server device). In some examples, a caption may be generated for insertion into at least one post of the plurality of posts, based on the score, and the caption may be inserted into the at least one post of the plurality of posts. Generally, operation 814 allows for posts to be manipulated and/or edited, based on score calculations disclosed herein.

In some examples, the caption may be generated for insertion into one or more of a variety of pages. For example, the caption may be generated for insertion into a blog post, product page, product listing page, article listing page, homepage, or another type of webpage (or portion thereof) that may be recognized by those of ordinary skill in the art. In some examples, an organization with multiple websites can create a network of content from one website to another website. For example, if a first organization owns or is otherwise associated with a second organization and a third organization, then websites associated with the first, second, and third organizations can send one or more posts to method 800 and be returned with relevant recommendations, such that a website can display results of relevant recommendations from its own content, as well as from other websites.

Method 800 may terminate at operation 814. Alternatively, method 800 may return to operation 802 (or any other operation from method 800) to provide an iterative loop, such as of receiving a plurality of posts, filtering and processing the plurality of posts, calculating a score for the filtered and processed plurality of posts, and providing each post from the plurality of posts as an output with the respective scores of each post.

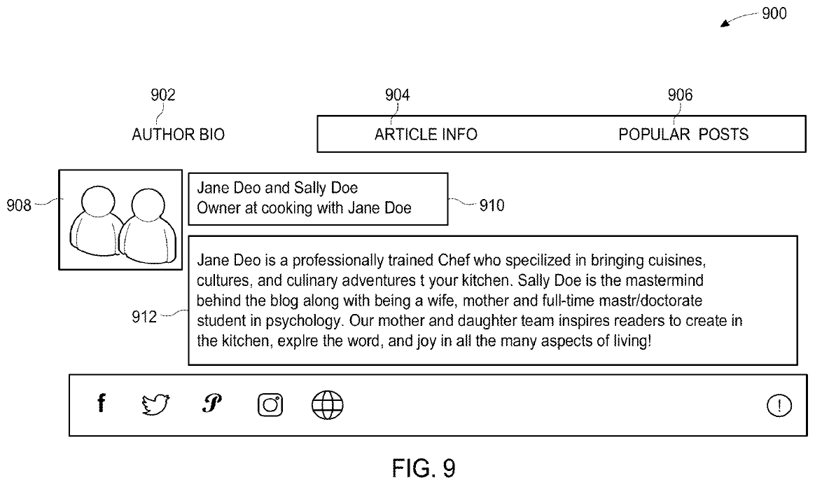

FIG. 9 illustrates an example graphical user-interface (GUI) or portion thereof 900, according to some aspects described herein. Generally, the GUI 900 may be a smart author box that adds personalized author info at the end of a post, automatically cross-links to related posts and/or new posts by the author, and sends a summary of every post, to which the smart author box is appended, in structured data (e.g., to a search engine system).

GUI 900 includes a first tab 902, a second tab 904, and a third tab 906. The first tab 902 is associated with a first configuration of the GUI 900 that displays an author bio. Accordingly, the first tab 902 may be an author bio. The second tab 904 is associated with a second configuration of the GUI 900 that display article info. Accordingly, the second tab 904 may be article info. The third tab 906 is associated with a third configuration of the GUI 900 that displays popular posts. Accordingly, the third tab 906 may be popular posts.

The author bio 902 includes an image 908, a title 910, and a description 912. The image 908 may be an image of an author to whom the author bio 902 corresponds. The title 910 may include a name and position of the author. For example, if the authors of a post associated with the GUI 900 are Jane and Sally Doe, owners of an organization entitled “Cooking with Jane Doe”, then the title 910 may include such information. The description 912 may contain information regarding the author and/or provided by the author (e.g., background regarding the author that may be relevant to a post to which the GUI 900 is appended). In some examples, the GUI 900 includes structured data corresponding to the content thereof (e.g., the author bio 902, the article info 904, the popular posts 906, the image 908, the title 910, and/or the description 912). In some examples, the structured data exists in a machine-friendly format, such as a lightweight linked data format (e.g., JSON-LD), for example to make it easier for search engines to consumer the structured data.

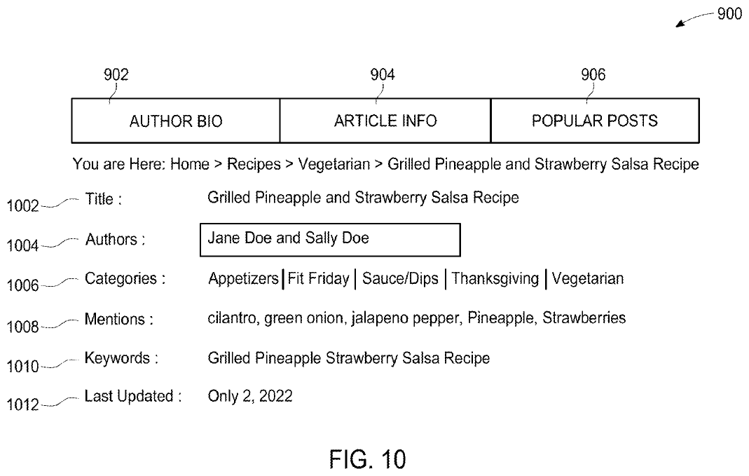

FIG. 10 illustrates the example graphical user-interface (GUI) or portion thereof 900 of FIG. 9, in the second configuration, according to some aspects described herein. As noted above, the second configuration is the article info 904. The article info includes a title 1002, an author 1004, a category 1006, a mention or tag 1008, a keyword 1010, and a last updated time 1012. The title 1002 may be the title of a post or article on which the GUI 900 is embedded or displayed. The author 1004 may be one or more authors of the post or article on which the GUI 900 is embedded or displayed. The categories 1006 may be one or more categories, from a list of predetermined categories for a site, associated with the post or article. The mention or tag 1008 may be one or more text strings that link to specific trends, categories, or topics. The keywords 1010 may be one or more keywords (e.g., words that are determined to be important for the article, such as, because they are in the title of the article) of the post or article. The last updated time 1012 may be a time at which the post or article was last updated (e.g., the time at which a user last edited, saved, and/or uploaded changes to the post or article). Each of the aspects of the article info 904 may be sent to a computing device or server as structured data that summarizes the post or article that it is associated therewith. In some examples, the GUI 900 includes structured data corresponding to the content thereof (e.g., the title 1002, the author 1004, the category 1006, the mention 1008, the keyword 1010, and/or the last updated time 1012). In some examples, the structured data exists in a machine-friendly format, such as a lightweight linked data format (e.g., JSON-LD), for example to make it easier for search engines to consumer the structured data.

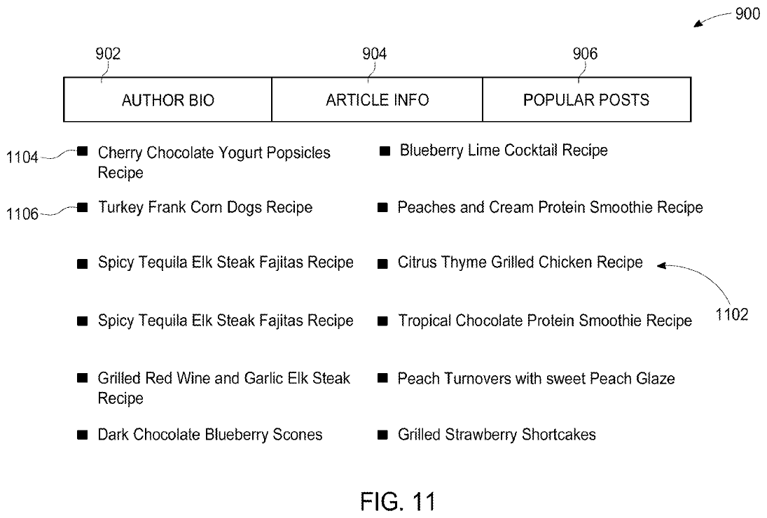

FIG. 11 illustrates the example graphical user-interface (GUI) or portion thereof 900 of FIG. 9, in the third configuration, according to some aspects described herein. As noted above, the third configuration is the popular posts 906. The popular posts 906 includes a plurality of posts 1102, such as a first post 1104 and a second post 1106. The plurality of posts 1102 may be displayed on the GUI 900 in lists. The plurality of posts 1102 may be ordered based on popularity, alphabetically, and/or another ordering that may be recognized by those of ordinary skill in the art in light of teachings described herein. In some examples, the GUI 900 includes structured data corresponding to the content thereof (e.g., the plurality of posts 1102, the first post 1104, and/or the second post 1106). In some examples, the structured data exists in a machine-friendly format, such as a lightweight linked data format (e.g., JSON-LD), for example to make it easier for search engines to consumer the structured data.

Each of the plurality of posts may include a uniform resource link (URL) that is hyperlinked on the GUI 900. The URLs may be selectable such that a user or system can navigate to a site associated with the selected URL. In some examples, the popular posts are a list of posts written by the same author, as the author 910 (e.g., discussed with respect to the first configuration of the GUI 900 of FIG. 9).

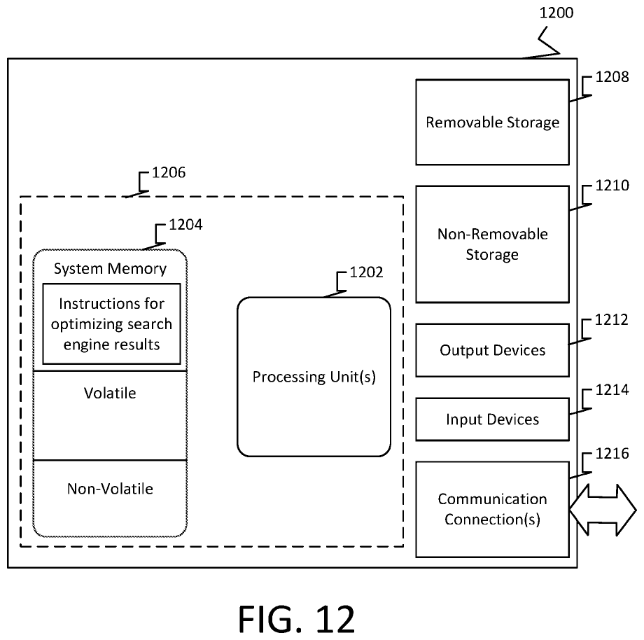

FIG. 12 illustrates a simplified block diagram of a device with which aspects of the present disclosure may be practiced in accordance with aspects of the present disclosure. The device may be a mobile computing device, for example. One or more of the present embodiments may be implemented in an operating environment 1200. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1200 typically includes at least one processing unit 1202 and memory 1204. Depending on the exact configuration and type of computing device, memory 1204 (e.g., instructions for optimizing search engine results, as disclosed herein, etc.) may be volatile (such as RAM), non-volatile (such as ROM, flash memory, etc.), or some combination of the two. This most basic configuration is illustrated in FIG. 12 by dashed line 1206. Further, the operating environment 1200 may also include storage devices (removable, 1208, and/or non-removable, 1210) including, but not limited to, magnetic or optical disks or tape. Similarly, the operating environment 1200 may also have input device(s) 1214 such as remote controller, keyboard, mouse, pen, voice input, on-board sensors, etc. and/or output device(s) 1212 such as a display, speakers, printer, motors, etc. Also included in the environment may be one or more communication connections 1216, such as LAN, WAN, a near-field communications network, a cellular broadband network, point to point, etc.

Operating environment 1200 typically includes at least some form of computer readable media. Computer readable media can be any available media that can be accessed by the at least one processing unit 1202 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1200 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

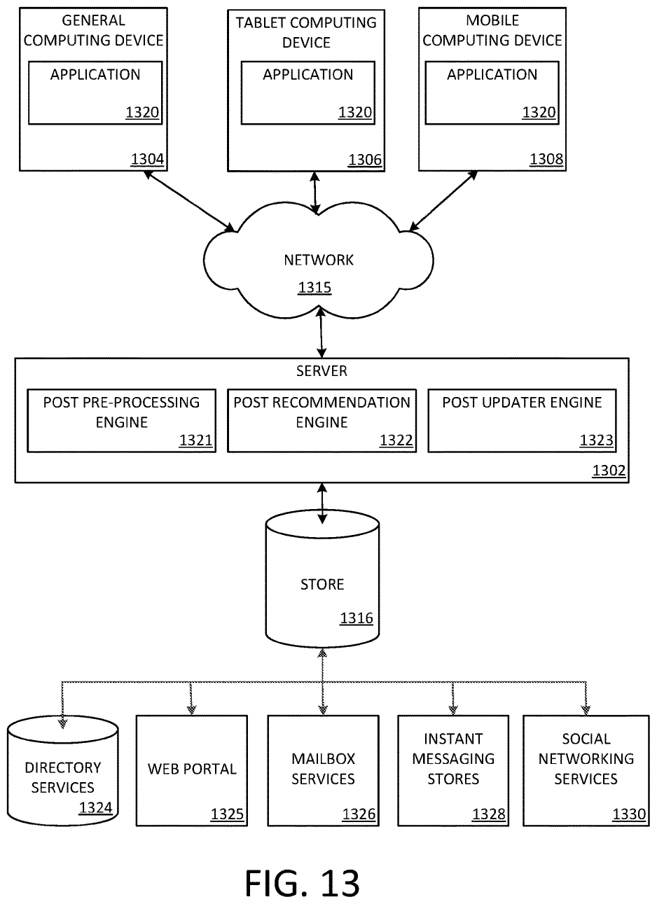

FIG. 13 illustrates one aspect of the architecture of a system for processing data received at a computing system from a remote source, such as a personal computer 1304, tablet computing device 1306, or mobile computing device 1308, as described above. Content displayed at server device 1302 may be stored in different communication channels or other storage types. For example, various documents may be stored using a directory service 1324, a web portal 1325, a mailbox service 1326, an instant messaging store 1328, or a social networking site 1330.

An application 1320 (e.g., that contains or is configured to execute the instructions in the system memory 1200) may be employed by a client that communicates with server device 1302. Additionally, or alternatively, post pre-processing engine 1321, post recommendation engine 1322, and/or post updater engine 1323 may be employed by server device 1302. The server device 1302 may provide data to and from a client computing device such as a personal computer 1304, a tablet computing device 1306 and/or a mobile computing device 1308 (e.g., a smart phone) through a network 1315. By way of example, the computer system described above may be embodied in a personal computer 1304, a tablet computing device 1306 and/or a mobile computing device 1308 (e.g., a smart phone). Any of these examples of the computing devices may obtain content from the store 1316, in addition to receiving graphical data useable to be either pre-processed at a graphic-originating system, or post-processed at a receiving computing system.

In some examples, method, systems, and media for fetching, formatting, joining, and amassing search engine data and CMS (content management system) meta data are provided, such as, for example, for the purpose of generating recommendations and optimizing content, automatically, on a website, to improve search engine results.

Upon creating an account to gain access to mechanisms disclosed herein (e.g., with a valid license), a website owner can proceed to configure mechanisms disclosed herein in a portal (e.g., a web portal, customer portal, etc.) by completing a setup wizard. In some examples, in response to creating an account, a user can install a plug-in (e.g., website plug-in), according to mechanisms disclosed herein, which communicates and/or syncs data between websites and a backend system provided herein.

The aforementioned setup wizard may allow a user to authenticate a connection to their website's search engine data (e.g., via a commercial search engine console). Upon authentication, mechanisms disclosed herein can verify that a correct website property is linked to a corresponding correct search engine data property.

In some examples, mechanisms disclosed herein can make an application programming interface (API) call to fetch search engine data from a search engine console, including, for example, the following query parameters: performance metrics (impressions, clicks, click-through rate, average rank position, etc.), query data (keywords/key phrases), landing page data (page URLs), country-level data, device data (mobile, desktop, tablet), and other search results data that those of ordinary skill in the art may recognize can be provided by a search engine. The search engine data may be stored in a database (e.g., database 210 and/or database 302, described earlier herein with respect to FIGS. 2 and 3).

In some examples, mechanisms disclosed herein can make API call to user's website to fetch meta data from their webpages and the contents thereof, including but not limited to, page uniform resource link (URL), page name (title), page description, page keywords, page categories and tags, page authors, and other page-level information. This data can also be stored in a database (e.g., database 210 and/or database 302, described earlier herein with respect to FIGS. 2 and 3).

In some examples, website meta data (e.g., as discussed above) and search engine data (e.g., also as discussed above) are joined together using a page URL as a primary key to filter and sort the highest performing pages based on one or more of the above parameters (e.g., query parameters). For example, the highest performing pages may include the top 200URLs (e.g., in a ranked list of greater than or equal to 200 URLs) with the 25 top queries (e.g., keywords, phrases, etc.) sorted by highest impressions, clicks, etc. Pages that are sorted and relatively highly ranked (e.g., the top 5, 10, 15, 20, 50, 100, or 200 pages of a list of sorted pages) according to mechanisms disclosed herein may be classified as “Power Posts”.

In some examples, mechanisms provided herein send data corresponding to ranked pages to a user's website backend and classifies the pages as “search engine power posts”. By indicating each webpage as such, webpages may become eligible for promotion on the website in multiple webpage interfaces, produced by a plug-in (e.g., plug-in 202 discussed with respect to FIG. 2), including but not limited to: author box at end of articles (e.g., as illustrated with respect to FIGS. 9-11), related posts list at end of articles (e.g., as discussed with respect to FIGS. 6 and 7), and featured placements on archive pages, result pages, and/or listing pages. In some examples, result pages include Author, Product, Category, Tag, and/or Author listing pages produced by a website.

In some examples, every 30 days, incremental API calls are made to retrieve updated search engine data. In some examples, updated search engine data accumulates on top of existing data and continues to be stored until an owner of, or user with accessibility permissions to, the database in which the search engine data is being stored deletes data, cleans data, and/or a license is deactivated for using mechanisms disclosed herein for a user for whom the search engine data was retrieved.

In some examples, the updated search engine data syncs with a website via the plug-in (e.g., plug-in 202) to maintain integrity of search engine power posts. In other words, deleted webpages may no longer be classified, and may no longer be promoted on various website interfaces.

In some examples, search engine data is used to qualify webpage recommendations in a related post component, according to mechanisms disclosed herein (e.g., as discussed with respect to FIGS. 6, 7, and 11). For example, a subset of webpages, from a plurality of webpages, that meet a minimum count of monthly impressions, may qualify to be merchandised and/or promoted in the related post component across a network of websites.

In some examples a power bio box component is provided. The power bio box component may include a graphical user interface. The graphical user interface is a mobile-responsive author box that shows author information, article information, and related content recommendations at the end of every article. The related content recommendations tab interface is where search engine power posts may appear as hyperlinks.

In some examples, a post miner is disclosed. The post miner may include functionality that injects and/or adds search engine power posts to corresponding archive, listing, and/or result pages. For example, a webpage can be archived or tagged with Category(ies), Tag(s), Authors, Products, Articles, and/or other collection or result pages.

In some examples, if a search engine power post is tagged as a specific archive and/or result type, those result pages can show a hyperlink to the search engine power post on a main result page, as well as paginated URLs (e.g., pages 1 through n) of the same result. For example, a Category result page which may have 100 total webpages, but only shows 20 webpages per page, will have 5 paginated component pages (e.g., pages 1-5). In some examples, search engine power posts in the same Category can be promoted and shown in the results on all 5 pages (e.g., using related post illustrations which may be similar to those in FIGS. 6 and 7 of the present disclosure).

In some examples, a relevancy editor component or power recommendations component or related posts component is provided. In some examples, the related posts component is a mobile-responsive list of webpage recommendations that shows recommendations which are computed by a recommendation engine or component disclosed herein (e.g., recommendation engine 222 and/or recommendation engine 318). Further, search engine power posts data can be used to exclude linking out to external sites from user's site, which do not meet minimum requirements (e.g., as discussed in further detail with respect to FIG. 5).

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method of optimizing search engine results, the method comprising:
receiving a plurality of posts, each post of the plurality of posts comprising a title and a uniform resource link (URL), and each post of the plurality of posts comprising at least one of a tag, a category, or a keyword;
removing, from the plurality of posts, at least one post that is determined to include a predetermined stopword in the respective title or URL of the post;
filtering, from the plurality of posts, at least one post to remove predefined common words from the title and the at least one of the tag, category, and keyword of each respective post;
calculating, after removing and filtering, a score for each post of the plurality of posts; and
providing, for the plurality of posts, as an output, each post and the respective scores of each post.

2. The method of claim 1, further comprising:
generating a caption for insertion into at least one post of the plurality of posts, based on the score; and
inserting the caption into the at least one post of the plurality of posts.

3. The method of claim 1, wherein the plurality of posts are received from a database, and wherein the output is provided to the database.

4. The method of claim 1, further comprising:
determining that a post of the plurality of posts contains a priority keyword in the post's title or URL; and
in response to determining, increasing the score.

5. The method of claim 1, wherein the titles comprise a first weight, the tags comprise a second weight, the categories comprise a third weight, and the keywords comprise a fourth weight, and wherein the score is based on the first weight and at least one of the second, third, and fourth weights.

6. The method of claim 1, wherein the first weight is greater than the second weight, the second weight is greater than the third weight, and the third weight is greater than the fourth weight.

7. The method of claim 1, wherein the first weight is a value of between about 0.7 and about 0.9.

8. The method of claim 1, wherein the plurality of posts are a plurality of blog posts.

9. A system for optimizing search engine results, the system comprising:
a first device;
a second device comprising a processor; and
memory storing instructions that, when executed by the processor, cause the system to perform a set of operations, the set of operations comprising:
receiving, from the first device, a plurality of posts, each post of the plurality of posts comprising a title and a uniform resource link (URL), and each post of the plurality of posts comprising at least one of a tag, a category, or a keyword;
removing, from the plurality of posts, at least one post that is determined to include a predetermined stopword in the respective title or URL of the post;
filtering, from the plurality of posts, at least one post to remove predefined common words from the title and the at least one of the tag, category, and keyword of each respective post;
calculating, after removing and filtering, a score for each post of the plurality of posts; and
generating a graphical user-interface (GUI), based on the score.

10. The system of claim 9, wherein the first device comprises a software plug-in.

11. The system of claim 10, further comprising:
sending each post and the respective score of each post to the software plug-in.

12. The system of claim 9, wherein the second device is a server.

13. The system of claim 9, wherein the graphical user interface comprises a plurality of images, corresponding to the plurality of posts.

14. The system of claim 9, further comprising:
determining that a post of the plurality of posts contains a priority keyword in the post's title or URL; and
in response to determining, increasing the score.

15. The system of claim 9, wherein the titles comprise a first weight, the tags comprise a second weight, the categories comprise a third weight, and the keywords comprise a fourth weight, and wherein the score is based on the first weight and at least one of the second, third, and fourth weights.

16. The system of claim 9, wherein the first weight is greater than the second weight, the second weight is greater than the third weight, and the third weight is greater than the fourth weight.

17. The system of claim 9, wherein the plurality of posts are a plurality of blog posts.

18. A non-transitory computer readable storage medium embodying software that is operable when executed, by at least one processor of a device, to:
receive a plurality of posts, each post of the plurality of posts comprising a title and a uniform resource link (URL), and each post of the plurality of posts comprising at least one of a tag, a category, or a keyword;
remove, from the plurality of posts, at least one post that is determined to include a predetermined stopword in the respective title or URL of the post;
filter, from the plurality of posts, at least one post to remove predefined common words from the title and the at least one of the tag, category, and keyword of each respective post;
calculate, after removing and filtering, a score for each post of the plurality of posts; and
provide, for the plurality of posts, as an output, each post and the respective scores of each post.

19. The non-transitory computer readable storage medium of claim 18, further being operable to:
generate a caption for insertion into at least one post of the plurality of posts, based on the score; and
insert the caption into the at least one post of the plurality of posts.

20. The non-transitory computer readable storage medium of claim 18, wherein the titles comprise a first weight, the tags comprise a second weight, the categories comprise a third weight, and the keywords comprise a fourth weight, and wherein the score is based on the first weight and at least one of the second, third, and fourth weights.
